(19) United States
(12) Patent Application Publication
(10) Pub. No.: US 2024/0371064 A1
(43) Pub. Date: Nov. 7, 2024

(54) AVATAR APPEARANCE SWAPPING THROUGH PHYSICAL MOTION

(71) Applicant: Meta Platforms Technologies, LLC, Menlo Park, CA (US)

(72) Inventor: Samuel Wu, New York, NY (US)

(21) Appl. No.: 18/652,668

(22) Filed: May 1, 2024

Related U.S. Application Data
(60) Provisional application No. 63/499,392, filed on May 1, 2023.

(51) Int. Cl. G06T 13/40; G06F 3/01; G06F 3/0485

(52) U.S. Cl. CPC G06T 13/40; G06F 3/017; G06F 3/0485

(57) ABSTRACT

Various aspects of the subject technology related to systems, methods, and machine-readable media for swapping avatars in a virtual environment using a physical action are implemented. The various aspects may include identifying a first virtual environment of a plurality of virtual environments. Various aspects may include generating a first avatar appearance from a plurality of avatar appearances wherein the first avatar appearance is correlated with the first virtual environment. Various aspects may include detecting a first physical command, wherein the first physical command is associated with a second avatar appearance from the plurality of avatar appearances. Various aspects may include retrieving the second avatar appearance. Various aspects may include replacing the first avatar appearance with the second avatar appearance. Further aspects may include timing features that reduce the possibility of inadvertent switching between avatars. The timing features can be contextual to the virtual environment or user established.

### CROSS-RELATED APPLICATIONS

The present application claims the benefit of priority under 35 U.S.C. § 119 (e) from U.S. Provisional Patent Application Ser. No. 63/499,392 entitled “AVATAR APPEARANCE SWAPPING THROUGH PHYSICAL MOTION,” filed on May 1, 2023, the disclosure of which is hereby incorporated by reference in its entirety for all purposes.

### TECHNICAL FIELD

The present disclosure relates generally to virtual environments and, more specifically, to avatar appearance swapping through physical motion.

### BACKGROUND

With the rise in the use of extended reality (XR), including augmented reality (AR), virtual reality (VR), and mixed reality (MR), the visual appearance of avatars has become increasingly important. There are many factors that go into the appearance of avatars including body shape, body size, clothes, shoes, arm length, leg length, body mass, hair style and color, and skin color. The fidelity of avatar rendering varies greatly based on the resources available for reproduction in different computing environments.

One important aspect of creating and rendering avatars is the avatar appearance in varying locations and context within the reality environment. Designers regularly create different options to customize different portions of the avatar to change the appearance of the avatar within the reality environment. Some appearance options are closely tied to specific locations within the reality environment, such as contextually relevant sports equipment when located on a playing field (e.g., shoulder pads as a clothing option when located on a hockey rink). Some appearance operations are associated with a wide range of environments and are considered as a normal appearance within such environments (e.g., wearing a black dress within an office and in a night club).

### SUMMARY

One aspect of the present disclosure relates to a method for swapping avatars in a virtual environment. In an exemplary method, the method comprises identifying a first virtual environment of a plurality of virtual environments. The method includes generating a first avatar appearance from a plurality of avatar appearances wherein the first avatar appearance is correlated with the first virtual environment. The method includes detecting a first physical command, wherein the first physical command is associated with a second avatar appearance from the plurality of avatar appearances. The method includes retrieving the second avatar appearance. The method can also include replacing the first avatar appearance with the second avatar appearance.

According to another aspect of the present disclosure, a system is provided. The system may include one or more processors. The system may include a memory storing instructions that, when executed by the one or more processors, cause the system to perform operations. The operations may include identifying a first virtual environment of a plurality of virtual environments. The operations may include generating a first avatar appearance from a plurality of avatar appearances wherein the first avatar appearance is correlated with the first virtual environment. The operations may include detecting a first physical command, wherein the first physical command is associated with a second avatar appearance from the plurality of avatar appearances. The operations may include retrieving the second avatar appearances. The operations may also include replacing the first avatar appearance with the second avatar appearance.

According to yet other aspects of the present disclosure, a non-transitory computer-readable storage medium storing instructions encoded thereon that, when executed by a processor, cause the processor to perform operations, is provided. The operations may include identifying a first virtual environment of a plurality of virtual environments. The operations may include generating a first avatar appearance from a plurality of avatar appearances wherein the first avatar appearance is correlated with the first virtual environment. The operations may include detecting a first physical command, wherein the first physical command is associated with a second avatar appearance from the plurality of avatar appearances. The operations may include retrieving the second avatar appearance. The operations may also include replacing the first avatar appearance with the second avatar appearance.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating components of an extended reality system, in accordance with various embodiments.

FIG. 2 illustrates an example of a user performing a physical command to cause the reality application of FIG. 1 to change avatar appearance sets in accordance with various embodiments.

FIG. 3 sets forth a flow diagram of method steps for switching an avatar appearance set in a reality application upon detecting a physical command, in accordance with various embodiments.

FIG. 4 is a block diagram of an embodiment of a near-eye display (NED) system in which a console operates in accordance with various embodiments.

FIG. 5A is a diagram of an NED in accordance with various embodiments.

FIG. 5B is another diagram of an NED in accordance with various embodiments.

### DETAILED DESCRIPTION

In the following description, numerous specific details are set forth to provide a more thorough understanding of the various embodiments. However, it will be apparent to one skilled in the art, that the inventive concepts may be practiced without one or more of these specific details.

One drawback of current reality applications is that such applications have difficulty changing the appearance of an avatar within the reality environment. For example, such systems usually include specific applications (e.g., an avatar store) or a specific menu outside of the reality environment that enables a user to change portions of an avatar appearance. However, such approaches are not integrated into the primary reality environment and require the user to exit from the primary reality environment to change appearance. As a result, many users avoid personalization of the avatar in order to continue experiences within the primary reality environment. Further, some users avoid changing appearance to a contextually relevant appearance when navigating through the primary reality environment, which may break the immersion of other users that view the avatar with an appearance that does not match the context of the environment (e.g., playing a football game wearing scuba equipment and holding a rolling pin). An effective and efficient technique to change an avatar appearance within an extended reality environment is needed.

This disclosure addresses user controls to perform quick switches of a set of avatar appearance choices, such as a physical gesture mapped to specific appearance sets or mapped to a specific appearance swap. In contrast to the traditional approach that requires a user to navigate to a separate menu, launch a separate program, or navigate to a specific location within a shared virtual reality environment, the disclosed techniques enable users to perform appearance changes for an avatar on-the-fly while remaining immersed within the shared virtual reality environment.

In the disclosed embodiments, a reality application causes a computing device to store separate sets of avatar appearances, including personalized choices regarding the body of the avatar (e.g., hair, skin color, makeup, body part shapes, etc.), clothing (e.g., shirts, jackets, pants, skirts, kilts, dresses, hats, gloves, shoes, etc.), and accessories (e.g., wearable devices, bags, portable objects like bats, skateboards, kitchen utensils, etc.). The reality application stores one or more physical gestures that are reserved to perform a switch between avatar appearance sets. The reality application receives acquired sensor data and identifies a physical gesture. The reality application determines the action mapped to the identified physical gesture and, upon determining that the identified physical gesture is mapped to a change in the avatar appearance set, swaps the avatar appearance set for the user within the reality environment. In some embodiments, the reality application can maintain a cooldown timer to avoid inadvertent physical gestures that would cause a rapid succession of quick switches.

### System Overview

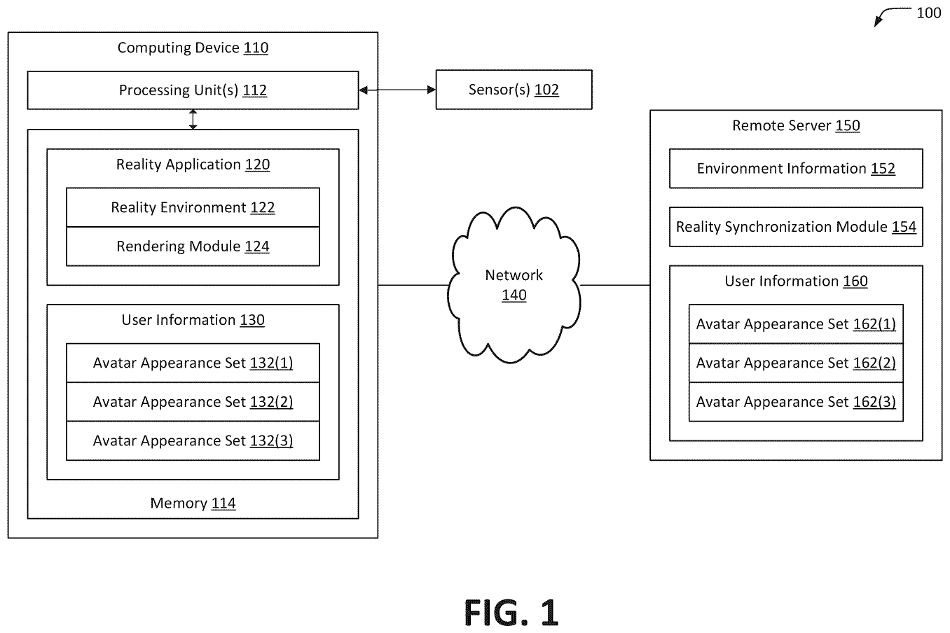

FIG. 1 is a block diagram illustrating components of an extended reality (XR) system 100, in accordance with various embodiments. As shown, and without limitation, the XR system 100 includes one or more sensors 102, a computing device 110, a network 140, and a remote server 150. The computing device 110 includes, without limitation, a processing unit 112, and memory 114. The memory 114 includes, without limitation, a reality application 120 and user information 130. The reality application 120 includes, without limitation, a reality environment 122 and a rendering module 124. The user information 130 includes, without limitation, multiple avatar appearance sets 132. The remote server 150 includes, without limitation, environment information 152, a reality synchronization module 154, and user information 160. The user information 160 includes, without limitation, multiple avatar appearance sets 162.

While some examples are illustrated, various features have not been illustrated for the sake of brevity and so as not to obscure pertinent aspects of the example embodiments disclosed herein. To that end, as a non-limiting example, the system 100 includes one or more sensors 102 (e.g., the sensors 102(1), 102(2), etc.) that are used in conjunction with one or more computing devices 110 (e.g., the computing devices 110(1), 110(2), 110(3), etc.). In some embodiments, the extended reality system 100 provides the functionality of a virtual reality device, or provides some other functionality.

In operation, the rendering module 124 of the reality application 120 generates the reality environment 122 that includes an avatar representing a user. The rendering module 124 renders the avatar with a selected avatar appearance set 132 (e.g., the avatar appearance set 132(1)) that includes multiple user selections relating to the appearance of the avatar. The sensors 102 acquires sensor data associated with physical motions of a user. The computing device 110 acquires the sensor data and determines that the physical motions include a physical command mapped to a change in the avatar appearance set of the avatar. The reality application 120 responds to the physical command by loading the corresponding avatar appearance set 132 (e.g., the avatar appearance set 132(2)) corresponding to the identified physical command. In various embodiments, the reality application 120 causes the rendering module 124 to perform the change in avatar appearance sets 132 while rendering the avatar in the reality environment 122 without displaying a menu for the change or exiting the reality environment 122.

The sensors 102 include one or more devices that collect data associated with objects in an environment. In various embodiments, the sensors 102 include an array of sensors that can be worn by the user, disposed separately at a fixed location, or movable. In some embodiments, the sensors 102 can be oriented toward the user. The sensors 102 can be disposed in any feasible manner in the environment.

In some embodiments, the sensors 102 include one or more devices that perform measurements and/or acquire data related to certain subjects in an environment. In various embodiments, the sensors 102 generate sensor data that is related to the user. For example, the sensors 102 can collect biometric data related to the user (e.g., muscle movement, eye blinks, eye saccades, etc.) Further, the sensors 102 could include a user-facing camera that records the face of the user as image data. Similarly, the sensors 102 could include a facial electromyography (fEMG) sensor that measures specific muscle contractions and associated activities (e.g., a raised eyebrow, clenched jaw, etc.) of the user. The reality application 120 could then analyze the image data in order to determine the facial expression of the user and determine whether a change in facial expression corresponds to a physical command.

In some embodiments, the sensors 102 include cameras that capture physical movements and/or gestures made by the user. For example, the user can make multiple gestures, such as various movements or orientations of the hands, arms, eyes, or other parts of the body that are received via the camera sensor 102. In such instance, one of the physical gestures the user made includes a physical command that triggers the reality application 120 to execute a switch of the avatar appearance set 132 for the avatar of the user.

The computing device 110 executes virtual reality applications and/or augmented reality applications (e.g., the reality application 120), processing sensor data from the sensors 102. The computing device 110 provides output data for an electronic display included in a head-mounted display (HMD). In various embodiments, the computing device 110 is included in an HMD that presents media to the user. Examples of media presented by computing device 110 include images, video, audio, or some combination thereof. In some embodiments, audio is presented via an external device (e.g., speakers and/or headphones) that receives audio information from the computing device 110. In some embodiments, the HMD includes one or more of the sensors 102. Alternatively, in some embodiments, the computing device 110 is a standalone device that is coupled to the HMD. The computing device 110 is sometimes called a host or a host system. In some embodiments, communications between the computing device 110 and the HMD occur via a wired or wireless connection between the computing device 110 and the HMD. In some embodiments, the computing device 110 and the HMD share a single communications bus. In various embodiments, the computing device 110 can be any suitable computer device, such as a laptop computer, a tablet device, a netbook computer, a personal digital assistant, a mobile phone, a smart phone, an XR device (e.g., a VR device, an AR device, or the like), a gaming device, a computer server, or any other computing device. In some embodiments, the computing device 110 includes other user interface components such as a keyboard, a touch-screen display, a mouse, a trackpad, and/or supplemental I/O devices to add functionality to the computing device 110.

The processing unit 112 can include a central processing unit (CPU), a digital signal processing unit (DSP), a microprocessor, an application-specific integrated circuit (ASIC), a neural processing unit (NPU), a graphics processing unit (GPU), a field-programmable gate array (FPGA), and so forth. The processing unit 112 generally comprises a programmable processor that executes program instructions to manipulate input data. In some embodiments, the processing unit 112 includes any number of processing cores, memories, and other modules for facilitating program execution. For example, the processing unit 112 receives sensor data via the sensors 102 and drives the reality application 120.

In another example, the processing unit 112 executes the reality application 120 to determine whether the user triggered a change in the avatar appearance set 132 associated with the avatar of the user. In such instances, the processing unit 112 can respond to the trigger by executing the reality application 120 to change to a stored avatar appearance set 132 (e.g., a change from avatar appearance set 132(1) to the avatar appearance set 132(2)).

The memory 114 includes a memory module, or collection of memory modules. The memory 114 can include a variety of computer-readable media selected for their size, relative performance, or other capabilities: volatile and/or non-volatile media, removable and/or non-removable media, etc. The memory 114 can include cache, random access memory (RAM), storage, etc. The memory 114 can include one or more discrete memory modules, such as dynamic RAM (DRAM) dual inline memory modules (DIMMs). Of course, various memory chips, bandwidths, and form factors may alternately be selected.

Non-volatile memory included in the memory 114 generally stores application programs including the reality application 120, and data (e.g., the user information 130), for processing by the processing unit 112. In various embodiments, the memory 114 includes non-volatile memory, such as optical drives, magnetic drives, flash drives, or other storage. In some embodiments, separate data stores, such as an external data store connected via the network 140 (“cloud storage”), can supplement the memory 114. The reality application 120 within the memory 114 can be executed by the processing unit 112 to implement the overall functionality of the computing device 110 and, thus, to coordinate the operation of the XR system 100 as a whole.

In various embodiments, the memory 114 includes one or more modules for performing various functions or techniques described herein. In some embodiments, one or more of the modules and/or applications included in memory 114 can be implemented locally on computing device 110, and/or can be implemented via a cloud-based architecture. For example, any of the modules and/or applications included in memory 114 could be executed on a remote device (e.g., smartphone, a server system, a cloud computing platform, etc.) that communicates with computing device 110 via a network interface or an input/output (I/O) device's interface.

The reality application 120 is an application that renders the reality environment 122. In various embodiments, the reality application 120 shares information with the remote server 150 to render the reality environment 122 as part of a shared virtual environment. For example, the reality environment 122 can be an instance of a massive multiplayer online (MMO) environment that includes multiple avatars representing multiple users. In such instances, the reality application 120 can share information with the reality synchronization module 154 in the remote server 150 to synchronize the reality environment 122 with other users. For example, the reality application 120 can receive the environment information 152 from the remote server 150 and cause the rendering module 124 in the reality application 120 to update the reality environment 122. In another example, the reality application 120 can cause the computing device 110 to transmit an update indicating the change in the avatar appearance set 132 being used by the avatar of the user. In such instances, the reality synchronization module 154 can update the environment information 152 that is to be transmitted to other users.

The user information 130, 160 includes various information associated with the user and/or user preferences. In various embodiments, copies of the user information 130, 160 can be stored in both the computing device 110 and the remote server 150. For example, the user information 130 can include a user identifier, contact information, authentication information (e.g., passwords, biometric information), user preferences, device identifiers, and so forth. In various embodiments, the user information 130 includes two or more avatar appearance sets 132. Each avatar appearance set 132 can include user selections for a group of personalization options, including body-related selections (e.g., body shape, skin color, eye color, hair style, hair color, etc.), clothing-related selections (e.g., selection of specific tops, bottoms, shoes, hats, wearable accessories), and other avatar-related accessories (e.g., a companion, such as a proximate animal or sentient object, portable accessories, auras, etc.). In such instances, the avatar appearance set 132 includes a combination of personalized selections that each modify the appearance of the avatar representing the user when rendered in the reality environment.

In various embodiments, privacy settings allow a user to specify whether the user's information may be measured and collected and whether an avatar may be personalized to the user. In addition, privacy settings allow a user to specify whether particular applications or processes may access, store, or use such information. In various embodiments, the system 100 may store particular privacy policies/guidelines in the privacy settings associated with a user. The privacy settings may allow users to opt in or opt out of having such information accessed, stored, or used by specific applications or processes. A user who wishes to enable this functionality may indicate in their privacy settings that they opt in to system 100 receiving the inputs necessary to generate and update an avatar. By contrast, if a user does not opt in to the system 100 receiving these inputs (or affirmatively opts out of the system receiving these inputs), the system 100 may be prevented from receiving, collecting, logging, or storing these inputs or any information associated with these inputs. In particular embodiments, if a user desires to make use of this function for specific purposes or applications, additional privacy settings may be specified by the user to opt in for the specific purposes or applications.

In various embodiments, the system 100 may have functionalities that may use, as inputs, personal or biometric information of a user for user-authentication or experience-personalization purposes. A user may opt to make use of these functionalities to enhance their experience within the system 100. The user's privacy settings may specify that such information may be used only for particular processes, such as authentication, and further specify that such information may not be shared with any third-party system or used for other processes or applications associated with the system 100.

In various embodiments, changes to privacy settings may take effect retroactively, affecting the use of information generated or measured prior to the change. In various embodiments, the change in privacy settings may take effect only going forward. In various embodiments, in response to a user action to change a privacy setting, the system 100 may further prompt the user to indicate whether the user wants to apply the changes to the privacy settings retroactively. In various embodiments, a user change to privacy settings may be a one-off change specific to specific information. In various embodiments, a user change to privacy may be a global change for all information associated with the user.

In particular embodiments, a user may need to provide verification of a privacy setting before allowing the user to perform particular actions on the system 100, or to provide verification before changing a particular privacy setting. When performing particular actions or changing a particular privacy setting, a prompt may be presented to the user to remind the user of their current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. In particular embodiments, a user may need to provide verification of a privacy setting on a periodic basis. A prompt or reminder may be periodically sent to the user based either on time elapsed or a number of user actions. As an example and not by way of limitation, the system 100 may send a reminder to the user to confirm his or her privacy settings every six months. In particular embodiments, privacy settings may also allow users to control access to information on a per-request basis. As an example and not by way of limitation, the system 100 may notify the user whenever a third-party system attempts to access information associated with the user, and require the user to provide verification that access should be allowed before proceeding.

In some embodiments, the user information 130, 160 includes specific mappings of physical commands to specific avatar appearance sets 132. For example, the user information 130 can store a specific physical motion (e.g., a crane-style pose) to switch to a specific avatar appearance set 132 (e.g., an avatar appearance set 132(3) associated with a Karate Gi clothing selection). Alternatively, in some embodiments, the user information 130 includes an auxiliary user interface (e.g., a quick-swap slot) that stores a previously selected avatar appearance set 132. In such instances, the user information can store a mapping of a physical command to the quick-swap slot such that detection of the quick-swap slot replaces the current avatar appearance set 132 (e.g., 132(1)) with the avatar appearance set 132 (e.g., 132(2)) that is stored in the quick-swap slot.

The network 140 includes a plurality of network communications systems, such as routers and switches, configured to facilitate data communication between computing device 110 and the remote server 150. Persons skilled in the art will recognize that many technically feasible techniques exist for building the network 140, including technologies practiced in deploying an Internet communications network. For example, network 140 may include a wide-area network (WAN), a local-area network (LAN), and/or a wireless (Wi-Fi) network, among others.

### Avatar Appearance Swapping

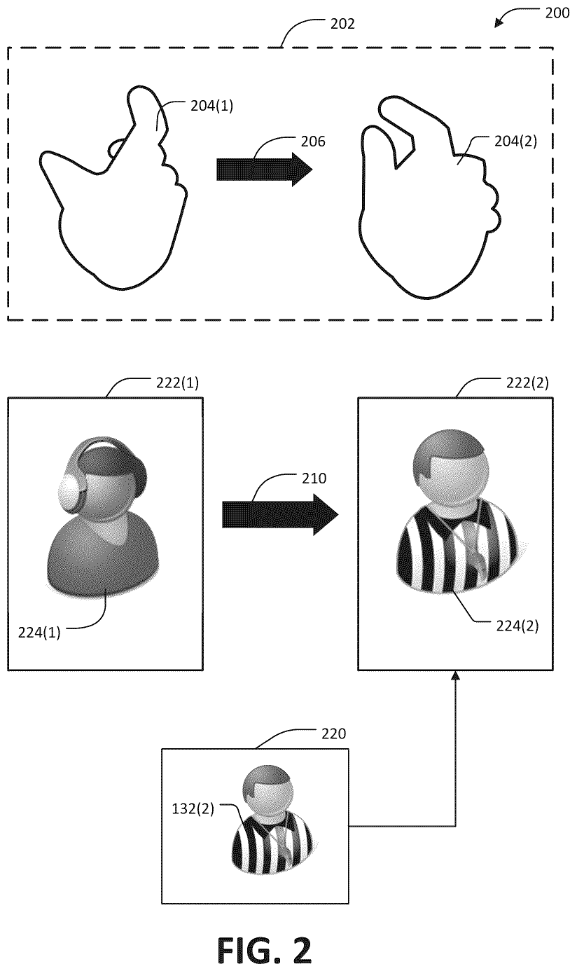

FIG. 2 illustrates an example of a user performing a physical command to cause the reality application 120 of FIG. 1 to change avatar appearance sets 132 in accordance with various embodiments. As shown, and without limitation, the environment 200 includes a physical environment 202, the reality environment 222, and a quick-swap slot 220. The physical environment 202 includes, without limitation, a hand 204 of the user. The reality environment 222 includes, without limitation, an avatar 224.

In operation, the computing device 110 receives sensor data of the physical environment 202. The sensor data includes image data indicating a physical movement associated with the hand 204 of the user moving from a first pose (e.g., 204(1)) to a second pose (e.g., 204(2)). The reality application 120 processes the sensor data and detects the movement as a pinching gesture 206. The reality application 120 identifies the pinching gesture 206 as a physical command mapped to an avatar appearance quick-swap action 210.

The reality application 120 responds by executing the avatar appearance quick-swap action 210. The reality application 120 retrieves the avatar appearance set 132 currently stored in the quick-swap slot 220 (e.g., the avatar appearance set 132(2)). The reality application 120 then substitutes the retrieved avatar appearance set 132(2) for the avatar appearance set 132 (e.g., the avatar appearance set 132(1)) that is currently applied to the avatar 224 (e.g., 224(1)) in the reality environment 222(1). The swap results in the reality environment 222(2), where the retrieved avatar appearance set 132(2) is applied to the avatar 224(2).

In some embodiments, the quick-swap slot can be a carousel of two or more stored avatar appearance sets 132. In such instances, the user can perform the physical command successively to cycle through the avatar appearance sets included in the carousel. Further, the reality application 120 can store multiple physical commands that map to different navigational controls. For example, the computing device 110 can include a first mapping that maps a first physical command (e.g., a left finger snap) to cycle clockwise through the carousel and maps a second physical command (e.g., a right finger snap) to cycle counterclockwise through the carousel.

In some embodiments, the reality application 120 can maintain a cooldown timer associated with specific actions. For example, the reality application 120 can start a cooldown timer upon performing the avatar appearance quick-swap action 210. In such instances, the reality application 120 can wait until the cooldown timer expires before performing subsequent switches of the avatar appearance set 132. In one example, the user sets the cooldown timer (e.g., 30 seconds). In some embodiments, the cooldown timer can be contextual. For example, a user can trigger an avatar appearance quick-swap action 210 before attending a virtual meeting. In such instances, the reality application 120 can set the timer such that the physical command is disabled for the duration of the meeting. In some embodiments, the cooldown timer can be linked to specific locations. For example, the reality application 120 can set the cooldown timer as functionally infinite while the avatar is within a specific area (e.g., wearing a uniform in a battle arena).

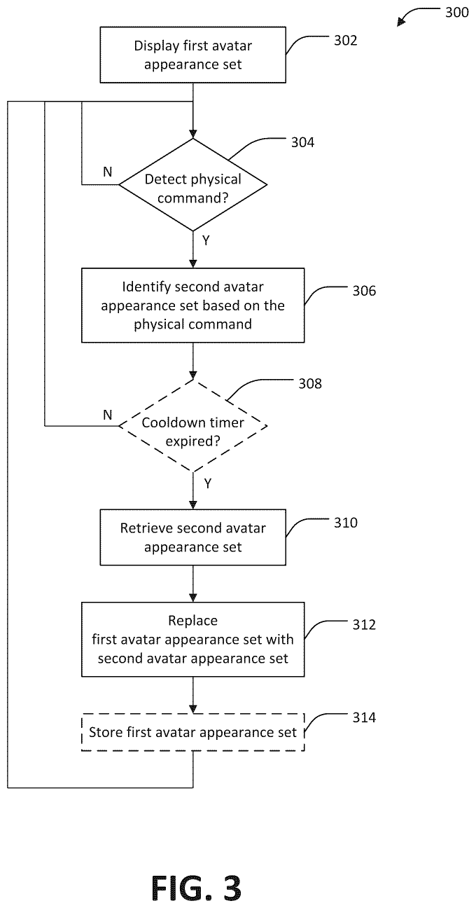

FIG. 3 sets forth a flow diagram of method steps for switching an avatar appearance set in a reality application upon detecting a physical command, in accordance with various embodiments. Although the method steps are described with respect to the systems of FIGS. 1-2, persons skilled in the art will understand that any system configured to perform the method steps, in any order, falls within the scope of the various embodiments. In some embodiments, the reality application 120 may continually execute the method 300 on captured sensor data in real time.

The method 300 begins at step 302, where the reality application 120 displays an avatar appearance set. In various embodiments, the rendering module 124 included in the reality application 120 renders the reality environment 122. The reality environment 122 includes an avatar 224 representing the user, where the rendering module 124 applies a first avatar appearance set 132(1) on the avatar 224.

At step 304, the reality application 120 determines whether the user performed an applicable physical command. In various embodiments, the reality application 120 processes sensor data received from the one or more sensors 102. In some embodiments, the reality application 120 processes the sensor data while the rendering module 124 is rendering the reality environment 122. The reality application 120 identifies one or more physical gestures from the sensor data and determines whether the one or more identified physical gestures correspond to a physical command to change the avatar appearance set 132. For example, the computing device 110 can include a quick-swap slot storing a separate avatar appearance set 132(2) and a mapping of a quick-swap action to a specific physical command (e.g., a motion mimicking the drawing of a bow). The computing device 110 can also store specific mappings of physical commands to specific avatar appearance sets 132 (e.g., mapping a twin arm windmill motion to the avatar appearance set 132(3)). In such instances, the reality application 120 can compare the one or more identified physical gestures to determine whether any of the one or more identified physical gestures correspond to one of the stored physical commands. When the reality application 120 determines that the user performed a physical command, the reality application 120 proceeds to step 306. Otherwise, the reality application 120 determines that no applicable physical command was detected and returns to step 304 to process additional sensor data.

At step 306, the reality application 120 identifies a second avatar appearance set 132(2) based on the detected physical command. In various embodiments, upon detecting the physical command, the reality application 120 identifies the second avatar appearance set 132 corresponding to the physical command. Using the above example, the reality application 120 can identify a specific avatar appearance set 132 mapped to the gesture (e.g., a specific physical command to select a specific avatar appearance set 132) or identify an avatar appearance set 132 stored in a specific slot (e.g., a specific physical command to select the avatar appearance set 132 stored in the quick-swap slot or within a carousel of options). In such instances, the reality application 120 identifies the applicable avatar appearance set 132 as the second avatar appearance set 132(2) to be used for a swap action.

At step 308, the reality application 120 optionally determines whether a cooldown timer has expired. In some embodiments, the reality application 120 maintains a cooldown timer associated with switching between avatar appearance sets 132. In such instances, the reality application 120 first determines whether the cooldown timer expired before executing the swap action. When the reality application 120 determines that the cooldown timer expired, the reality application 120 proceeds to step 310. Otherwise, the reality application 120 determines that the cooldown timer has not expired and returns to step 304 to process further sensor data. In such instances, the user may be required to perform the physical gesture after the cooldown timer expires to trigger the reality application 120 to perform the swap action.

At step 310, the reality application 120 retrieves the second avatar appearance set 132(2). In various embodiments, the reality application 120 retrieves the avatar appearance set 132 identified as the second avatar appearance set 132(2) that is to be used in the swap action. In some embodiments, the reality application 120 retrieves the second avatar appearance set 132(2) from the local memory 114. Alternatively, in some embodiments, the reality application 120 transmits a request to the remote server 150 for the avatar appearance set 162 corresponding to the second avatar appearance set 132(2) (e.g., the avatar appearance set 162(2)).

At step 312, the reality application 120 substitutes the second avatar appearance set 132(2) for the first avatar appearance set 132(1). In various embodiments, the rendering module 124 in the reality application 120 performs the swap action by updating the reality environment 122 by applying the second avatar appearance set 132(2) to the avatar 224 in lieu of the first avatar appearance set 132(1). In various embodiments, the reality application 120 causes the rendering module 124 to perform the swap action without opening a menu, exiting the reality environment 122, or pausing immersion of the avatar within the reality environment 122. For example, the rendering module 124 can apply an animation (e.g., a puff of smoke or spark of light) within the reality environment 122 when transitioning between avatar appearance sets 132.

At step 314, the reality application 120 optionally stores the first avatar appearance set 132. In various embodiments, the reality application 120 can optionally store the first avatar appearance set 132(1) locally in the memory 114. For example, the reality application 120 can retrieve from the remote server 150 an avatar appearance set 162 corresponding to the first avatar appearance set 132(1) and store the retrieved avatar appearance set 132 as the first avatar appearance set 132(1). Additionally or alternatively, in some embodiments, the reality application 120 can store the first avatar appearance set 132(1) in a specific slot associated with the swap action. For example, as part of the swap action, the reality application 120 can store the first avatar appearance set 132(1) in the quick-swap slot 220 that previously stored the second avatar appearance set 132(2). In another example, the reality application 120 can store the first avatar appearance set 132(1) in one of the slots of a multi-slot carousel. Upon storing the first avatar appearance set 132(1), the reality application 120 can return to step 304 to process further sensor data.

### The Artificial Reality System

Embodiments of the disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) or near-eye display (NED) connected to a host computer system, a standalone HMD or NED, a mobile device or computing system, or any other hardware platform capable of providing artificial reality content to one or more viewers.

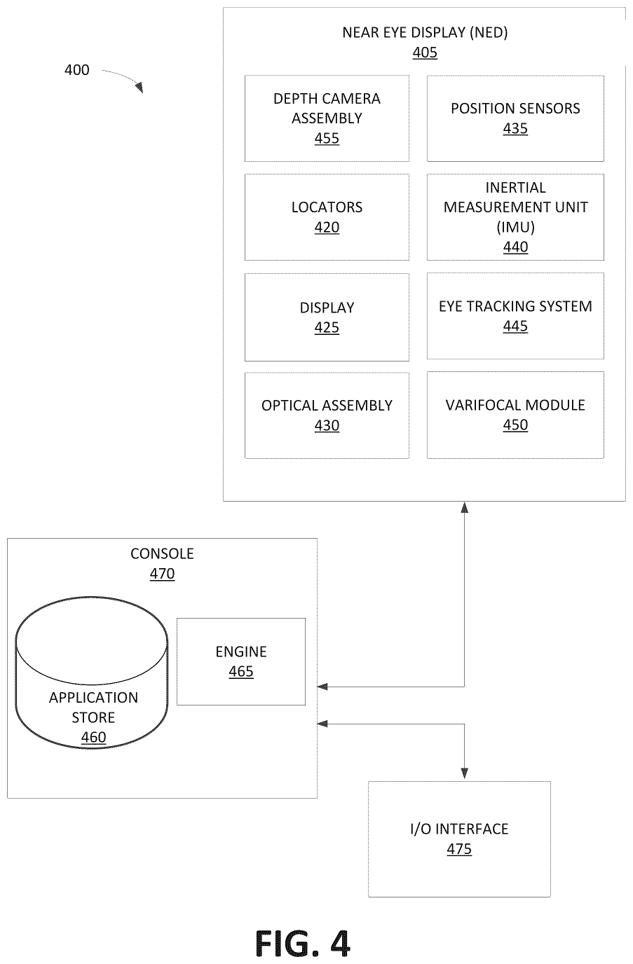

FIG. 4 is a block diagram of an embodiment of a near-eye display (NED) system 400 in which a console operates, according to various embodiments. The NED system 400 may operate in a virtual reality (VR) system environment, an augmented reality (AR) system environment, a mixed reality (MR) system environment, or some combination thereof. The NED system 400 shown in FIG. 4 comprises an NED 405 and an input/output (I/O) interface 475 that is coupled to the console 470. In various embodiments, the composite display system 400 is included in or operates in conjunction with the NED system 400. For example, the composite display system 400 may be included within NED 405 or may be coupled to the console 470 and/or the NED 405.

While FIG. 4 shows an example NED system 400 including one NED 405 and one I/O interface 475, in other embodiments any number of these components may be included in the NED system 400. For example, there may be multiple NEDs 405, and each NED 405 has an associated I/O interface 475. Each NED 405 and I/O interface 475 communicates with the console 470. In alternative configurations, different and/or additional components may be included in the NED system 400. Additionally, various components included within the NED 405, the console 470, and the I/O interface 475 may be distributed in a different manner than is described in conjunction with FIGS. 1-3B, in some embodiments. For example, some or all of the functionality of the console 470 may be provided by the NED 405 and vice versa.

The NED 405 may be a head-mounted display that presents content to a user. The content may include virtual and/or augmented views of a physical, real-world environment including computer-generated elements (e.g., two-dimensional or three-dimensional images, two-dimensional or three-dimensional video, sound, etc.). In some embodiments, the NED 405 may also present audio content to a user. The NED 405 and/or the console 470 may transmit the audio content to an external device via the I/O interface 475. The external device may include various forms of speaker systems and/or headphones. In various embodiments, the audio content is synchronized with visual content being displayed by the NED 405.

The NED 405 may comprise one or more rigid bodies, which may be rigidly or non-rigidly coupled together. A rigid coupling between rigid bodies causes the coupled rigid bodies to act as a single rigid entity. In contrast, a non-rigid coupling between rigid bodies allows the rigid bodies to move relative to each other.

As shown in FIG. 4, the NED 405 may include a depth camera assembly (DCA) 455, one or more locators 420, a display 425, an optical assembly 430, one or more position sensors 435, an inertial measurement unit (IMU) 440, an eye tracking system 445, and a varifocal module 450. In some embodiments, the display 425 and the optical assembly 430 can be integrated together into a projection assembly. Various embodiments of the NED 405 may have additional, fewer, or different components than those listed above. Additionally, the functionality of each component may be partially or completely encompassed by the functionality of one or more other components in various embodiments.

The DCA 455 captures sensor data describing depth information of an area surrounding the NED 405. The sensor data may be generated by one or a combination of depth imaging techniques, such as triangulation, structured light imaging, time-of-flight imaging, stereo imaging, laser scan, and so forth. The DCA 455 can compute various depth properties of the area surrounding the NED 405 using the sensor data. Additionally or alternatively, the DCA 455 may transmit the sensor data to the console 470 for processing. Further, in various embodiments, the DCA 455 captures or samples sensor data at different times. For example, the DCA 455 could sample sensor data at different times within a time window to obtain sensor data along a time dimension.

The DCA 455 includes an illumination source, an imaging device, and a controller. The illumination source emits light onto an area surrounding the NED 405. In an embodiment, the emitted light is structured light. The illumination source includes a plurality of emitters that each emits light having certain characteristics (e.g., wavelength, polarization, coherence, temporal behavior, etc.). The characteristics may be the same or different between emitters, and the emitters can be operated simultaneously or individually. In one embodiment, the plurality of emitters could be, e.g., laser diodes (such as edge emitters), inorganic or organic light-emitting diodes (LEDs), a vertical-cavity surface-emitting laser (VCSEL), or some other source. In some embodiments, a single emitter or a plurality of emitters in the illumination source can emit light having a structured light pattern. The imaging device captures ambient light in the environment surrounding NED 405, in addition to light reflected off of objects in the environment that is generated by the plurality of emitters. In various embodiments, the imaging device may be an infrared camera, or a camera configured to operate in a visible spectrum. The controller coordinates how the illumination source emits light and how the imaging device captures light. For example, the controller may determine a brightness of the emitted light. In some embodiments, the controller also analyzes detected light to detect objects in the environment and position information related to those objects.

The locators 420 are objects located in specific positions on the NED 405 relative to one another and relative to a specific reference point on the NED 405. A locator 420 may be a light emitting diode (LED), a corner cube reflector, a reflective marker, a type of light source that contrasts with an environment in which the NED 405 operates, or some combination thereof. In embodiments where the locators 420 are active (i.e., an LED or other type of light emitting device), the locators 420 may emit light in the visible band (˜340 nm to 950 nm), in the infrared (IR) band (˜950 nm to 9700 nm), in the ultraviolet band (70 nm to 340 nm), some other portion of the electromagnetic spectrum, or some combination thereof.

In some embodiments, the locators 420 are located beneath an outer surface of the NED 405, which is transparent to the wavelengths of light emitted or reflected by the locators 420 or is thin enough not to substantially attenuate the wavelengths of light emitted or reflected by the locators 420. Additionally, in some embodiments, the outer surface or other portions of the NED 405 are opaque in the visible band of wavelengths of light. Thus, the locators 420 may emit light in the IR band under an outer surface that is transparent in the IR band but opaque in the visible band.

The display 425 displays two-dimensional or three-dimensional images to the user in accordance with pixel data received from the console 470 and/or one or more other sources. In various embodiments, the display 425 comprises a single display or multiple displays (e.g., separate displays for each eye of a user). In some embodiments, the display 425 comprises a single or multiple waveguide displays. Light can be coupled into the single or multiple waveguide displays via, e.g., a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, a laser-based display, one or more waveguides, other types of displays, a scanner, a one-dimensional array, and so forth. In addition, combinations of the display types may be incorporated in display 425 and used separately, in parallel, and/or in combination.

The optical assembly 430 magnifies image light received from the display 425, corrects optical errors associated with the image light, and presents the corrected image light to a user of the NED 405. The optical assembly 430 includes a plurality of optical elements. For example, one or more of the following optical elements may be included in the optical assembly 430: an aperture, a Fresnel lens, a convex lens, a concave lens, a filter, a reflecting surface, or any other suitable optical element that deflects, reflects, refracts, and/or in some way alters image light. Moreover, the optical assembly 430 may include combinations of different optical elements. In some embodiments, one or more of the optical elements in the optical assembly 430 may have one or more coatings, such as partially reflective or anti-reflective coatings.

In some embodiments, the optical assembly 430 may be designed to correct one or more types of optical errors. Examples of optical errors include barrel or pincushion distortions, longitudinal chromatic aberrations, or transverse chromatic aberrations. Other types of optical errors may further include spherical aberrations, chromatic aberrations or errors due to the lens field curvature, astigmatisms, in addition to other types of optical errors. In some embodiments, visual content transmitted to the display 425 is pre-distorted, and the optical assembly 430 corrects the distortion as image light from the display 425 passes through various optical elements of the optical assembly 430. In some embodiments, optical elements of the optical assembly 430 are integrated into the display 425 as a projection assembly that includes at least one waveguide coupled with one or more optical elements.

The IMU 440 is an electronic device that generates data indicating a position of the NED 405 based on measurement signals received from one or more of the position sensors 435 and from depth information received from the DCA 455. In some embodiments of the NED 405, the IMU 440 may be a dedicated hardware component. In other embodiments, the IMU 440 may be a software component implemented in one or more processors.

In operation, a position sensor 435 generates one or more measurement signals in response to a motion of the NED 405. Examples of position sensors 435 include: one or more accelerometers, one or more gyroscopes, one or more magnetometers, one or more altimeters, one or more inclinometers, and/or various types of sensors for motion detection, drift detection, and/or error detection. The position sensors 435 may be located external to the IMU 440, internal to the IMU 440, or some combination thereof.

Based on the one or more measurement signals from one or more position sensors 435, the IMU 440 generates data indicating an estimated current position of the NED 405 relative to an initial position of the NED 405. For example, the position sensors 435 include multiple accelerometers to measure translational motion (forward/back, up/down, left/right) and multiple gyroscopes to measure rotational motion (e.g., pitch, yaw, and roll). In some embodiments, the IMU 440 rapidly samples the measurement signals and calculates the estimated current position of the NED 405 from the sampled data. For example, the IMU 440 integrates the measurement signals received from the accelerometers over time to estimate a velocity vector and integrates the velocity vector over time to determine an estimated current position of a reference point on the NED 405. Alternatively, the IMU 440 provides the sampled measurement signals to the console 470, which analyzes the sample data to determine one or more measurement errors. The console 470 may further transmit one or more of control signals and/or measurement errors to the IMU 440 to configure the IMU 440 to correct and/or reduce one or more measurement errors (e.g., drift errors). The reference point is a point that may be used to describe the position of the NED 405. The reference point may generally be defined as a point in space, or a position related to a position and/or orientation of the NED 405.

In various embodiments, the IMU 440 receives one or more parameters from the console 470. The one or more parameters are used to maintain tracking of the NED 405. Based on a received parameter, the IMU 440 may adjust one or more IMU parameters (e.g., a sample rate). In some embodiments, certain parameters cause the IMU 440 to update an initial position of the reference point so that it corresponds to a next position of the reference point. Updating the initial position of the reference point as the next calibrated position of the reference point helps reduce drift errors in detecting a current position estimate of the IMU 440.

In various embodiments, the eye tracking system 445 is integrated into the NED 405. The eye-tracking system 445 may comprise one or more illumination sources (e.g., infrared illumination source, visible light illumination source) and one or more imaging devices (e.g., one or more cameras). In operation, the eye tracking system 445 generates and analyzes tracking data related to a user's eyes as the user wears the NED 405. In various embodiments, the eye tracking system 445 estimates the angular orientation of the user's eye. The orientation of the eye corresponds to the direction of the user's gaze within the NED 405. The orientation of the user's eye is defined herein as the direction of the foveal axis, which is the axis between the fovea (an area on the retina of the eye with the highest concentration of photoreceptors) and the center of the eye's pupil. In general, when a user's eyes are fixed on a point, the foveal axes of the user's eyes intersect that point. The pupillary axis is another axis of the eye that is defined as the axis passing through the center of the pupil and that is perpendicular to the corneal surface. The pupillary axis does not, in general, directly align with the foveal axis. Both axes intersect at the center of the pupil, but the orientation of the foveal axis is offset from the pupillary axis by approximately −1° to 8° laterally and +4° vertically. Because the foveal axis is defined according to the fovea, which is located in the back of the eye, the foveal axis can be difficult or impossible to detect directly in some eye tracking embodiments. Accordingly, in some embodiments, the orientation of the pupillary axis is detected, and the foveal axis is estimated based on the detected pupillary axis.

In general, movement of an eye corresponds not only to an angular rotation of the eye, but also to a translation of the eye, a change in the torsion of the eye, and/or a change in shape of the eye. The eye tracking system 445 may also detect translation of the eye, i.e., a change in the position of the eye relative to the eye socket. In some embodiments, the translation of the eye is not detected directly, but is approximated based on a mapping from a detected angular orientation. Translation of the eye corresponding to a change in the eye's position relative to the detection components of the eye tracking unit may also be detected. Translation of this type may occur, for example, due to a shift in the position of the NED 405 on a user's head. The eye tracking system 445 may also detect the torsion of the eye, i.e., rotation of the eye about the pupillary axis. The eye tracking system 445 may use the detected torsion of the eye to estimate the orientation of the foveal axis from the pupillary axis. The eye tracking system 445 may also track a change in the shape of the eye, which may be approximated as a skew or scaling linear transform or a twisting distortion (e.g., due to torsional deformation). The eye tracking system 445 may estimate the foveal axis based on some combination of the angular orientation of the pupillary axis, the translation of the eye, the torsion of the eye, and the current shape of the eye.

As the orientation may be determined for both eyes of the user, the eye tracking system 445 is able to determine where the user is looking. The NED 405 can use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other function that is based in part on the orientation of at least one of the user's eyes, or some combination thereof. Determining a direction of a user's gaze may include determining a point of convergence based on the determined orientations of the user's left and right eyes. A point of convergence may be the point where the two foveal axes of the user's eyes intersect (or the nearest point between the two axes). The direction of the user's gaze may be the direction of a line through the point of convergence and through the point halfway between the pupils of the user's eyes.

In some embodiments, the varifocal module 450 is integrated into the NED 405. The varifocal module 450 may be communicatively coupled to the eye tracking system 445 in order to enable the varifocal module 450 to receive eye tracking information from the eye tracking system 445. The varifocal module 450 may further modify the focus of image light emitted from the display 425 based on the eye tracking information received from the eye tracking system 445. Accordingly, the varifocal module 450 can reduce vergence-accommodation conflict that may be produced as the user's eyes resolve the image light. In various embodiments, the varifocal module 450 can be interfaced (e.g., either mechanically or electrically) with at least one optical element of the optical assembly 430.

In operation, the varifocal module 450 may adjust the position and/or orientation of one or more optical elements in the optical assembly 430 in order to adjust the focus of image light propagating through the optical assembly 430. In various embodiments, the varifocal module 450 may use eye tracking information obtained from the eye tracking system 445 to determine how to adjust one or more optical elements in the optical assembly 430. In some embodiments, the varifocal module 450 may perform foveated rendering of the image light based on the eye tracking information obtained from the eye tracking system 445 in order to adjust the resolution of the image light emitted by the display 425. In this case, the varifocal module 450 configures the display 425 to display a high pixel density in a foveal region of the user's eye-gaze and a low pixel density in other regions of the user's eye-gaze.

The I/O interface 475 facilitates the transfer of action requests from a user to the console 470. In addition, the I/O interface 475 facilitates the transfer of device feedback from the console 470 to the user. An action request is a request to perform a particular action. For example, an action request may be an instruction to start or end capture of image or video data or an instruction to perform a particular action within an application, such as pausing video playback, increasing or decreasing the volume of audio playback, and so forth. In various embodiments, the I/O interface 475 may include one or more input devices. Example input devices include: a keyboard, a mouse, a game controller, a joystick, and/or any other suitable device for receiving action requests and communicating the action requests to the console 470. In some embodiments, the I/O interface 475 includes an IMU 440 that captures calibration data indicating an estimated current position of the I/O interface 475 relative to an initial position of the I/O interface 475.

In operation, the I/O interface 475 receives action requests from the user and transmits those action requests to the console 470. Responsive to receiving the action request, the console 470 performs a corresponding action. For example, responsive to receiving an action request, console 470 may configure I/O interface 475 to emit haptic feedback onto an arm of the user. For example, console 470 may configure I/O interface 475 to deliver haptic feedback to a user when an action request is received. Additionally or alternatively, the console 470 may configure the I/O interface 475 to generate haptic feedback when the console 470 performs an action, responsive to receiving an action request.

The console 470 provides content to the NED 405 for processing in accordance with information received from one or more of: the DCA 455, the eye tracking system 445, one or more other components of the NED 405, and the I/O interface 475. In the embodiment shown in FIG. 4, the console 470 includes an application store 460 and an engine 465. In some embodiments, the console 470 may have additional, fewer, or different modules and/or components than those described in conjunction with FIG. 4. Similarly, the functions further described below may be distributed among components of the console 470 in a different manner than described in conjunction with FIG. 4.

The application store 460 stores one or more applications for execution by the console 470. An application is a group of instructions that, when executed by a processor, performs a particular set of functions, such as generating content for presentation to the user. For example, an application may generate content in response to receiving inputs from a user (e.g., via movement of the NED 405 as the user moves his/her head, via the I/O interface 475, etc.). Examples of applications include gaming applications, conferencing applications, video playback applications, or other suitable applications.

In some embodiments, the engine 465 generates a three-dimensional mapping of the area surrounding the NED 405 (i.e., the “local area”) based on information received from the NED 405. In some embodiments, the engine 465 determines depth information for the three-dimensional mapping of the local area based on depth data received from the NED 405. In various embodiments, the engine 465 uses depth data received from the NED 405 to update a model of the local area and to generate and/or modify media content based in part on the updated model of the local area.

The engine 465 also executes applications within the NED system 400 and receives position information, acceleration information, velocity information, predicted future positions, or some combination thereof, of the NED 405. Based on the received information, the engine 465 determines various forms of media content to transmit to the NED 405 for presentation to the user. For example, if the received information indicates that the user has looked to the left, the engine 465 generates media content for the NED 405 that mirrors the user's movement in a virtual environment or in an environment augmenting the local area with additional media content. Accordingly, the engine 465 may generate and/or modify media content (e.g., visual and/or audio content) for presentation to the user. The engine 465 may further transmit the media content to the NED 405. Additionally, in response to receiving an action request from the I/O interface 475, the engine 465 may perform an action within an application executing on the console 470. The engine 465 may further provide feedback when the action is performed. For example, the engine 465 may configure the NED 405 to generate visual and/or audio feedback and/or the I/O interface 475 to generate haptic feedback to the user.

In some embodiments, based on the eye tracking information (e.g., orientation of the user's eye) received from the eye tracking system 445, the engine 465 determines a resolution of the media content provided to the NED 405 for presentation to the user on the display 425. The engine 465 may adjust a resolution of the visual content provided to the NED 405 by configuring the display 425 to perform foveated rendering of the visual content, based at least in part on a direction of the user's gaze received from the eye tracking system 445. The engine 465 provides the content to the NED 405 having a high resolution on the display 425 in a foveal region of the user's gaze and a low resolution in other regions, thereby reducing the power consumption of the NED 405. In addition, using foveated rendering reduces a number of computing cycles used in rendering visual content without compromising the quality of the user's visual experience. In some embodiments, the engine 465 can further use the eye tracking information to adjust a focus of the image light emitted from the display 425 in order to reduce vergence-accommodation conflicts.

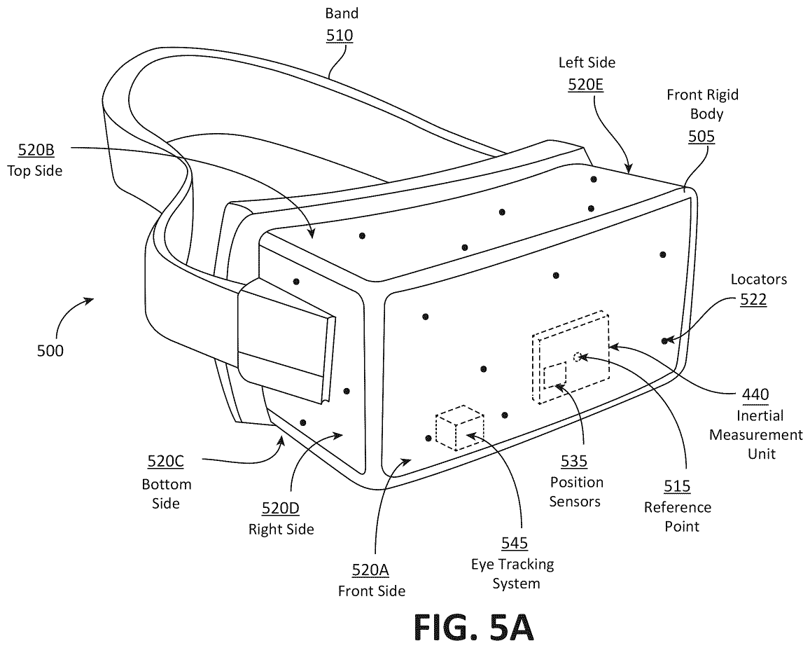

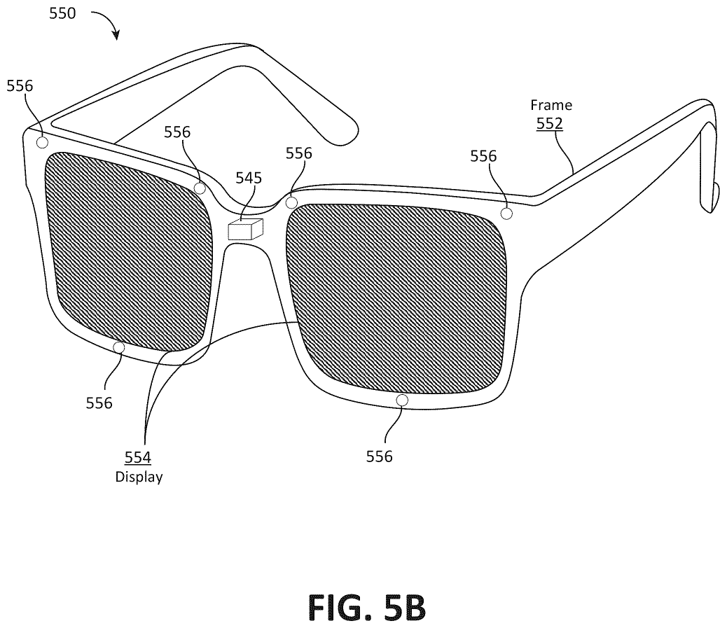

FIG. 5A is a diagram of an NED 500, according to various embodiments. In various embodiments, NED 500 presents media to a user. The media may include visual, auditory, and haptic content. In some embodiments, NED 500 provides artificial reality (e.g., virtual reality) content by providing a real-world environment and/or computer-generated content. In some embodiments, the computer-generated content may include visual, auditory, and haptic information. The NED 500 is an embodiment of the NED 405 and includes a front rigid body 505 and a band 510. The front rigid body 505 includes an electronic display element of the electronic display 425 (not shown in FIG. 5A), the optics assembly 430 (not shown in FIG. 5A), the IMU 440, the one or more position sensors 535, the eye tracking system 545, and the locators 522. In the embodiment shown by FIG. 5A, the position sensors 535 are located within the IMU 440, and neither the IMU 440 nor the position sensors 535 are visible to the user.

The locators 522 are located in fixed positions on the front rigid body 505 relative to one another and relative to a reference point 515. In the example of FIG. 5A, the reference point 515 is located at the center of the IMU 440. Each of the locators 522 emits light that is detectable by the imaging device in the DCA 455. The locators 522, or portions of the locators 522, are located on a front side 520A, a top side 520B, a bottom side 520C, a right side 520D, and a left side 520E of the front rigid body 505 in the example of FIG. 5A.

The NED 500 includes the eye tracking system 545. As discussed above, the eye tracking system 545 may include a structured light generator that projects an interferometric structured light pattern onto the user's eye and a camera to detect the illuminated portion of the eye. The structured light generator and the camera may be located off the axis of the user's gaze. In various embodiments, the eye tracking system 545 may include, additionally or alternatively, one or more time-of-flight sensors and/or one or more stereo depth sensors. In FIG. 5A, the eye tracking system 545 is located below the axis of the user's gaze, although the eye tracking system 545 can alternately be placed elsewhere. Also, in some embodiments, there is at least one eye tracking unit for the left eye of the user and at least one tracking unit for the right eye of the user.

In various embodiments, the eye tracking system 545 includes one or more cameras on the inside of the NED 500. The camera(s) of the eye tracking system 545 may be directed inwards, toward one or both eyes of the user while the user is wearing the NED 500, so that the camera(s) may image the eye(s) and eye region(s) of the user wearing the NED 500. The camera(s) may be located off the axis of the user's gaze. In some embodiments, the eye tracking system 545 includes separate cameras for the left eye and the right eye (e.g., one or more cameras directed toward the left eye of the user and, separately, one or more cameras directed toward the right eye of the user).

FIG. 5B is a diagram of an NED 550, according to various embodiments. In various embodiments, NED 550 presents media to a user. The media may include visual, auditory, and haptic content. In some embodiments, NED 550 provides artificial reality (e.g., augmented reality) content by providing a real-world environment and/or computer-generated content. In some embodiments, the computer-generated content may include visual, auditory, and haptic information. The NED 550 is an embodiment of the NED 405.

NED 550 includes frame 552 and display 554. In various embodiments, the NED 550 may include one or more additional elements. Display 554 may be positioned at different locations on the NED 550 than the locations illustrated in FIG. 5B. Display 554 is configured to provide content to the user, including audiovisual content. In some embodiments, one or more displays 554 may be located within frame 552.

NED 550 further includes eye tracking system 545 and one or more corresponding modules 556. The modules 556 may include emitters (e.g., light emitters) and/or sensors (e.g., image sensors, cameras). In various embodiments, the modules 556 are arranged at various positions along the inner surface of the frame 552, so that the modules 556 are facing the eyes of a user wearing the NED 550. For example, the modules 556 could include emitters that emit structured light patterns onto the eyes and image sensors to capture images of the structured light pattern on the eyes. As another example, the modules 556 could include multiple time-of-flight sensors for directing light at the eyes and measuring the time of travel of the light at each pixel of the sensors. As a further example, the modules 556 could include multiple stereo depth sensors for capturing images of the eyes from different vantage points. In various embodiments, the modules 556 also include image sensors for capturing 2D images of the eyes.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

Aspects of the present disclosure are described above with reference to flowchart illustrations and/or block diagrams of methods, apparatus (systems) and computer program products, according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially or concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for substituting an avatar appearance, the method comprising:
identifying a first virtual environment of a plurality of virtual environments;
generating a first avatar appearance from a plurality of avatar appearances wherein the first avatar appearance is correlated with the first virtual environment;
detecting a first physical command, wherein the first physical command is associated with a second avatar appearance from the plurality of avatar appearances;
retrieving the second avatar appearance; and
replacing the first avatar appearance with the second avatar appearance.

2. The method of claim 1, wherein detecting the first physical command, comprises:
processing sensor data to identify a physical gesture performed by a user; and
identifying at least one mapping to an action or at least one avatar appearance set that includes the identified physical gesture as the physical command.

3. The method of claim 1, wherein at least one supplemental physical command is configured to scroll through the plurality of avatar appearances and the first physical command is used to select the second avatar appearance.

4. The method of claim 1, further comprising determining that a cooldown timer associated with replacing the first avatar appearance has expired before replacing the first avatar appearance set applied to an avatar with a second avatar appearance set.

5. The method of claim 4, wherein a cooldown time configuration restricts a replacement of an avatar appearance based on the virtual environment.

6. The method of claim 1, wherein the plurality of avatar appearances associated are displayed in an auxiliary user interface.

7. The method of claim 6, further comprising receiving a notification to access a second virtual environment, wherein a select group of the plurality of avatar appearances are displayed in an auxiliary user interface.

8. The method of claim 7, wherein the select group of the plurality of avatar appearances are based on previous interactions with the second virtual environment.

9. A system for substituting an avatar appearance comprising:
one or more processors; and
a memory comprising instructions stored thereon, which when executed by the one or more processors, causes the one or more processors to perform:
identifying a first virtual environment of a plurality of virtual environments;
generating a first avatar appearance from a plurality of avatar appearances wherein the first avatar appearance is correlated with the first virtual environment;
detecting a first physical command, wherein the first physical command is associated with a second avatar appearance from the plurality of avatar appearances, and wherein the plurality of avatar appearances associated are displayed in an auxiliary user interface;
retrieving the second avatar appearance; and
replacing the first avatar appearance with the second avatar appearance.

10. The system of claim 9, wherein detecting the first physical command comprises:
processing sensor data to identify a physical gesture performed by the user; and
identifying at least one mapping to an action or at least one avatar appearance set that includes the identified physical gesture as the physical command.

11. The system of claim 9, wherein at least one supplemental physical command is configured to scroll through the plurality of avatar appearances and the first physical command is used to select the second avatar appearance.

12. The system of claim 9, further comprising determining that a cooldown timer associated with replacing the first avatar appearance has expired before replacing the first avatar appearance set applied to an avatar with a second avatar appearance set.

13. The system of claim 12, wherein a cooldown time configuration restricts a replacement of an avatar appearance based on the virtual environment.

14. The system of claim 13, further comprising receiving a notification to access a second virtual environment, wherein a select group of the plurality of avatar appearances are displayed in an auxiliary user interface.

15. The system of claim 14, wherein the select group of the plurality of avatar appearances are based on previous interactions with the second virtual environment.

16. A non-transitory computer-readable storage medium comprising instructions stored thereon, which when executed by one or more processors, cause the one or more processors to perform operations for substituting an avatar appearance, comprising:
identifying a first virtual environment of a plurality of virtual environments;
generating a first avatar appearance from a plurality of avatar appearances wherein the first avatar appearance is correlated with the first virtual environment, and wherein the plurality of avatar appearances associated are displayed in an auxiliary user interface;
detecting a first physical command, wherein the first physical command is associated with a second avatar appearance from the plurality of avatar appearances;
retrieving the second avatar appearance; and
replacing the first avatar appearance with the second avatar appearance.

17. The non-transitory computer-readable storage medium of claim 16, wherein detecting the first physical command comprises:
processing sensor data to identify a physical gesture performed by the user; and
identifying at least one mapping to an action or at least one avatar appearance set that includes the identified physical gesture as the physical command.

18. The non-transitory computer-readable storage medium of claim 16, wherein at least one supplemental physical command is configured to scroll through the plurality of avatar appearances and the first physical command is used to select the second avatar appearance.

19. The non-transitory computer-readable storage medium of claim 16, further comprising determining that a cooldown timer associated with replacing the first avatar appearance has expired before replacing the first avatar appearance set applied to an avatar with a second avatar appearance set.

20. The non-transitory computer-readable storage medium of claim 16, further comprising receiving a notification to access a second virtual environment, wherein a select group of the plurality of avatar appearances are displayed in an auxiliary user interface.
